(19) United States
(12) Patent Application Publication
(10) Pub. No.: US 2025/0073110 A1
(43) Pub. Date: Mar. 6, 2025

(54) CERVICAL TRACTION APPARATUS AND METHOD OF USE

(71) Applicant: RUIE GAO, Brisbane (AU)

(72) Inventor: RUIE GAO, Brisbane (AU)

(21) Appl. No.: 18/460,544

(22) Filed: Sep. 2, 2023

(51) Int. Cl. A61H 1/02

(52) U.S. Cl. CPC A61H 1/0229; A61H 2201/0126; A61H 2201/0192; A61H 2201/1261; A61H 2201/1607; A61H 2201/1652; A61H 2203/0406; A61H 2203/0431; A61H 2203/0487

(57) ABSTRACT

The present disclosure relates to a cervical traction apparatus designed for therapeutic use, featuring an anchor point for secure attachment. The apparatus comprises a cohesive framework assembly primarily composed of parallel extension springs and two connection panels. Integral components such as a head halter, a spreader bar, a positioning mat, and an adjustable chain are included. The apparatus is specifically configured to apply traction force by harnessing the restoring force generated by the parallel extension springs. The design facilitates the fine-tuning of traction force by adjusting the number of parallel extension springs. The apparatus is intended for the patient to adopt a standing position, promoting active stretching during the traction session. It can also be employed while seated, in conjunction with a user-provided chair. The design recognizes the interdependent relationship between the cervical spine, associated muscles, and other spinal components, treating them as a unified entity during the traction process.

### TECHNICAL FIELD

This disclosure pertains to the utilization of a traction device. More specifically, the current invention is predominantly focused on a cervical traction device designed for addressing various medical conditions, such as radiculopathy or nerve compression, vertebral fractures, spinal stenosis, degenerative disc disease, cervical spondylosis, and scoliosis.

### BACKGROUND

Cervical spinal traction is a well-established non-surgical and drug-free treatment method widely acknowledged for its safety and effectiveness in managing chronic neck conditions associated with disc herniation and joint degeneration. This therapeutic approach involves gently elongating the cervical spine to alleviate disc pressure and promote an optimal healing environment.

While various traction apparatuses have been developed to facilitate cervical spine traction, existing options at hospitals tend to be cumbersome and require the assistance of trained professionals, making them expensive and time-consuming for most patients. On the other hand, some home therapy apparatuses are overly simplistic, relying on manual force or counterforce applied by patients using their hands or legs. Furthermore, these apparatuses often lack the capability to easily adjust traction strength, limiting their efficacy.

Additionally, most existing apparatuses require patients to assume a sitting or lying position, resulting in unfamiliar stretching of the associated muscles while undergoing cervical spine traction. This unfamiliar stretching frequently leads to muscle spasms, undermining the therapy's effectiveness. Therefore, there is a significant demand for a simple yet effective therapy apparatus that allows patients to adjust the traction strength based on their preference and body weight. Moreover, the apparatus should enable patients to proactively stretch the associated muscles while undergoing traction, promoting natural movement, and ensuring a more comfortable and effective cervical spinal traction therapy experience.

Accordingly, it can be seen that needs exist for the cervical traction apparatus disclosed herein. It is to the provision of a cervical traction apparatus that is configured to address these need and others, that the present invention is primarily directed.

### BRIEF DESCRIPTION OF THE DRAWINGS

These and other features and advantages of various embodiments disclosed herein will be better understood with respect to the following description of drawings, wherein,

FIG. 1 showcases a frontal view of the cervical traction apparatus and an anchor point prepared for patient use, featuring parallel extension springs in a free state, in accordance with the principles outlined in the present disclosure.

FIG. 2 provides an enlarged depiction of a segment of the traction apparatus in operation, showcasing the cohesive framework featuring extension coil springs in an extended state, alongside the securely affixed head halter on the patient's head.

FIG. 3 depicts an exploded view to elucidate the secure attachment of a swivel hook end to the connection panel within the integrated framework.

FIG. 4 presents an enlarged depiction of the secure and parallel connection between an extension spring's hook and the connection panel within the integrated framework, resulting in a unified assembly.

FIG. 5 displays a frontal perspective of the patient actively engaged in neck rotation exercises while utilizing the cervical traction apparatus during a cervical traction session.

FIGS. 6 and 7 depicts a lateral view of the patient dynamically participating in the chest stretch and march in place movements, respectively, aimed at alleviating tension in upper body muscles while utilizing the cervical traction apparatus during a cervical traction session.

FIG. 8 demonstrates a lateral view of the patient engaging in an active spinal extension stretch while utilizing the cervical traction apparatus during a cervical traction session, leading to the attainment of a well-defined cervical traction angle.

FIG. 9 provides an enlarged illustration of the patient's involvement in intermittent cervical traction, demonstrated by manually lowering the head halter to the base of the neck for intermittent periods of rest.

FIG. 10 presents a side view of the patient using cervical traction while seated, employing the cervical traction apparatus in conjunction with a chair.

Common reference numerals are used throughout the drawings and the detailed description to indicate the same elements.

### DETAILED DESCRIPTION

The following detailed description, in conjunction with the accompanying drawings, presents the currently preferred embodiments of the invention. It should be noted that these embodiments are not the exclusive forms in which the apparatus can be developed or utilized. It is understood that various other embodiments capable of achieving the same or equivalent functions are also intended to be encompassed within the spirit and scope of the invention.

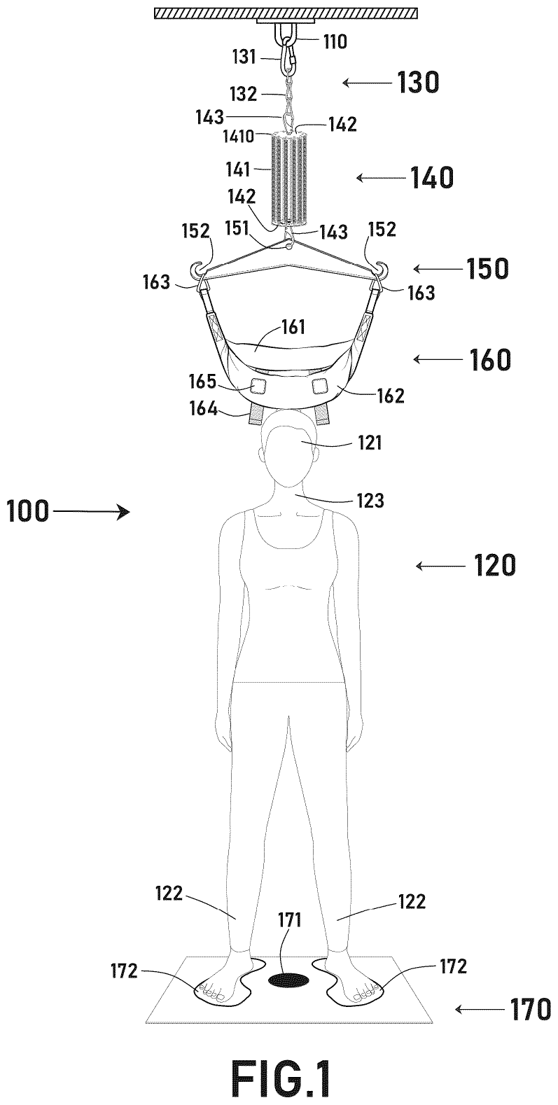

Referring to FIG. 1, a frontal view is depicted of a cervical traction apparatus 100 prepared for a patient 120 to use, attached to an anchor point 110, according to an aspect of the invention. As is illustrated, the patient 120 assumes a standing position, and a head halter 160 is adjusted to a position just above the head 121 of the patient 120 by modifying the length of an adjustable chain 130.

According to an aspect of the invention, there is provided the cervical traction apparatus 100 for use with the patient 120 and the anchor point 110. The apparatus 100 incorporates the adjustable chain130, which consists of multiple carabiner clips 131 and an interlocked chain segment 132. These components can be joined in a flexible manner. Each carabiner clip 131 has the capability to be inserted or detached independently, either with or without utilization of the interlocked chain 132, thereby enabling effortless adjustment of the overall length of adjustable chain130. The apparatus 100 further includes a cohesive framework 140 comprising a plurality of parallel extension springs 141, two of connection panels 142, where each of the connection panel 142 incorporates a swivel hook 143. The apparatus 100 further includes a spreader bar150 with one lifting point 151 located at the top middle portion, being seized, and configured to be attached to the bottom size of the cohesive framework 140, along with two of pick points 152 positioned at the opposing ends of the bottom. The cervical traction apparatus 100 further includes the head halter 160 comprising two cross straps wherein a back strap 161 being fastened and attached to the backside of the patient 120 in alignment with their occiput, as well as a front strap 162 being seized and attached to the chin of the patient 120, two of loop straps 164 and two of hooks 165 to ensure stability, with two of attachment points 163 suspended from the spread bar150.

The cervical traction apparatus 100 further includes a positioning mat 170. The positioning mat 170 is placed on the floor. A printed dot 171, positioned at the centre of the positioning mat 170, serving as a visual reference point, is intended to align with the anchor point 110, forming a vertical line perpendicular to the floor. Two of foot outlines 172 are printed on either side of the printed dot 171. The patient 120 stands on the positioning mat 170 and ensures that their feet 122 are cantered on the foot outlines 172 throughout the entire traction session.

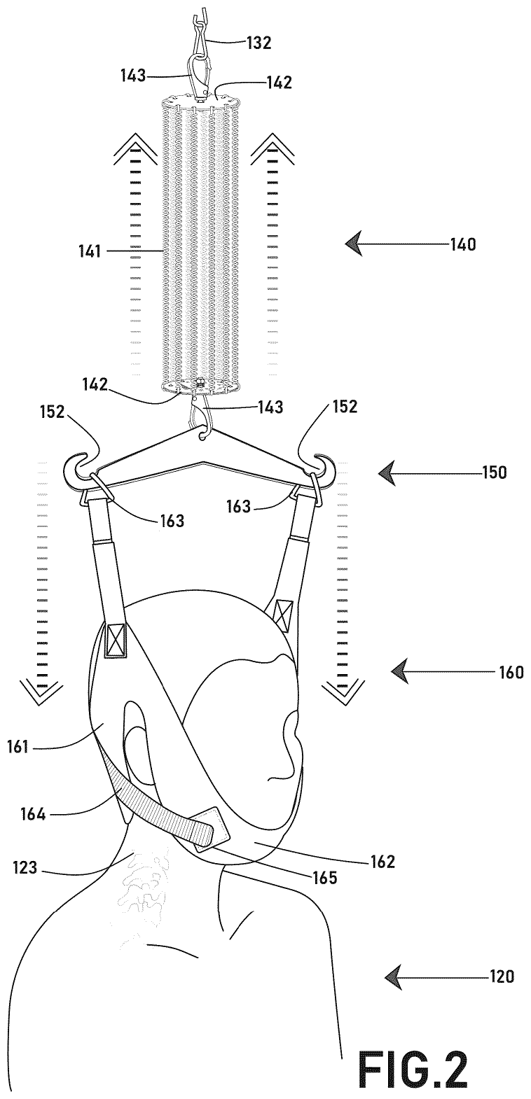

Referring to FIG. 2, there is illustrated an enlarged view of a portion of the cervical traction apparatus 100 that includes the cohesive framework 140 with the parallel extension springs 141 in an extended position and the head halter 160 already attached to the head 121 of the patient 120. As the patient 120 applies downward force to pull the head halter 160 from the top of the head 121 to the position of the neck 123, and subsequently attaches the head halter 160 to the head 121, the parallel extension springs 141 undergo a transition from a free position to an extended position. This transition generates an upward traction force that applies traction and decompresses the cervical spine of the patient 120.

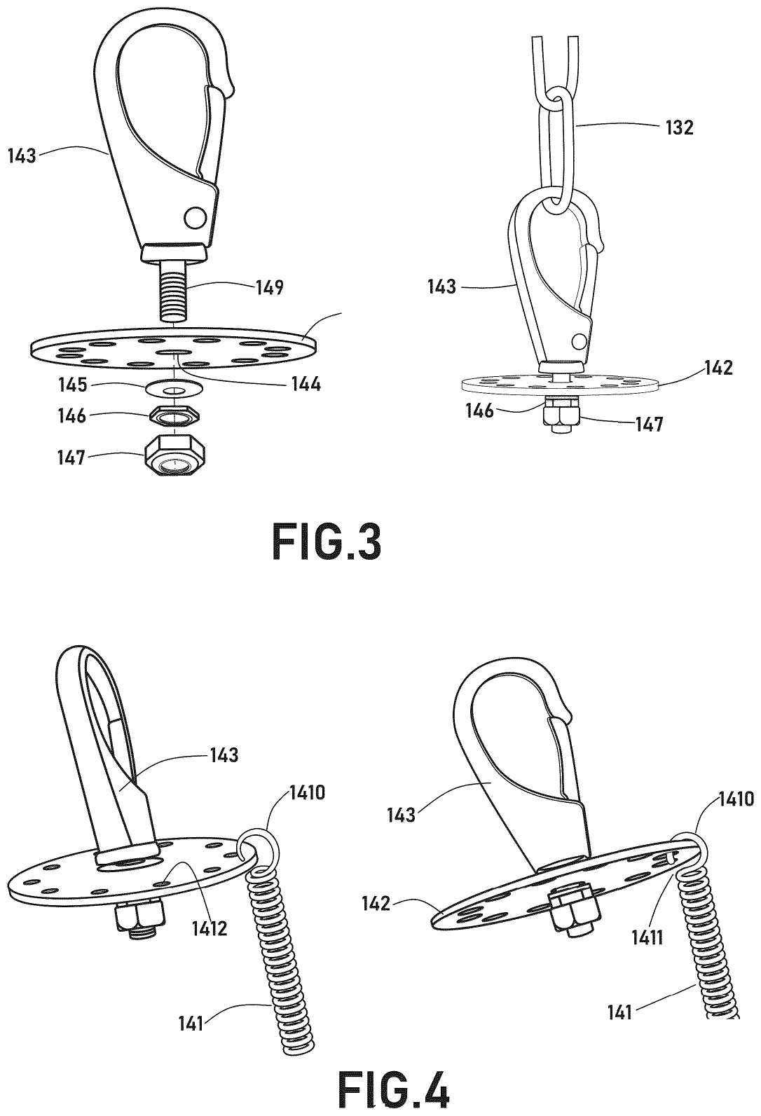

Referring to FIG. 3, the swivel hook 143 is centrally positioned within each of the connection panels 142 situated within the cohesive framework 140. The bolt of the swivel hook 143 is threaded through the central aperture 144 of the connection panel 142 and followed by the insertion of an anchoring gasket 145. The anchoring gasket is securely affixed in place through the use of both a thin nut 146 and a thick nut 147. The thin nut 146 is placed first, the thick nut 147 is then screwed tightly against the thin nut 146 until it reaches its maximum tightness, creating a wedging action on the bolt to prevent loosening, The length of the bolt thread 149 of the swivel hook 143 aligns precisely with the combined lengths of the thick nut 147 and the thin nut 146. Following the installation, the swivel hook 143 possesses the capacity to pivot freely through a 180-degree range of motion around the connection panel 142.

Referring to FIG. 4, the cohesive framework 140 incorporates extension springs 141 arranged in a parallel configuration. Each extension spring 141 is furnished with a pair of cross-over centre hooks 1410 at both ends, ensuring secure attachment. These cross-over centre hooks 1410 possess a gap 1411 precisely matching the thickness of the two connection panels 142, allowing for effortless attachment and detachment. The edges of the two connection panels 142 are adorned with an array of circular round holes 1412, with the quantity of holes 1412 corresponding to the number of extension springs 141. These circular round holes 1412 function as load points for the extension springs 141, enabling them to evenly distribute the load.

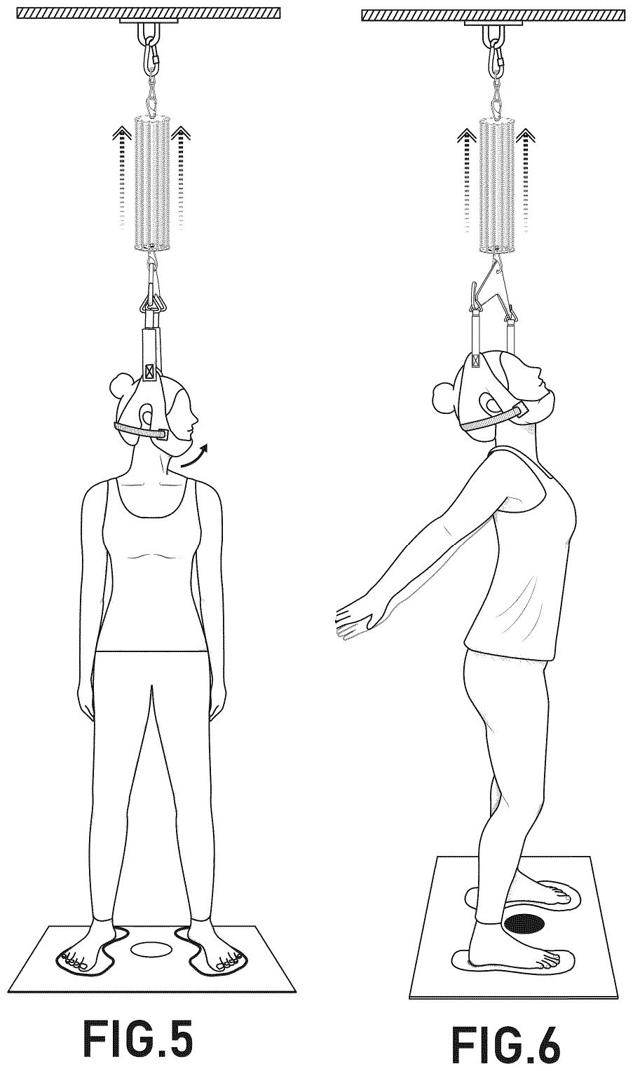

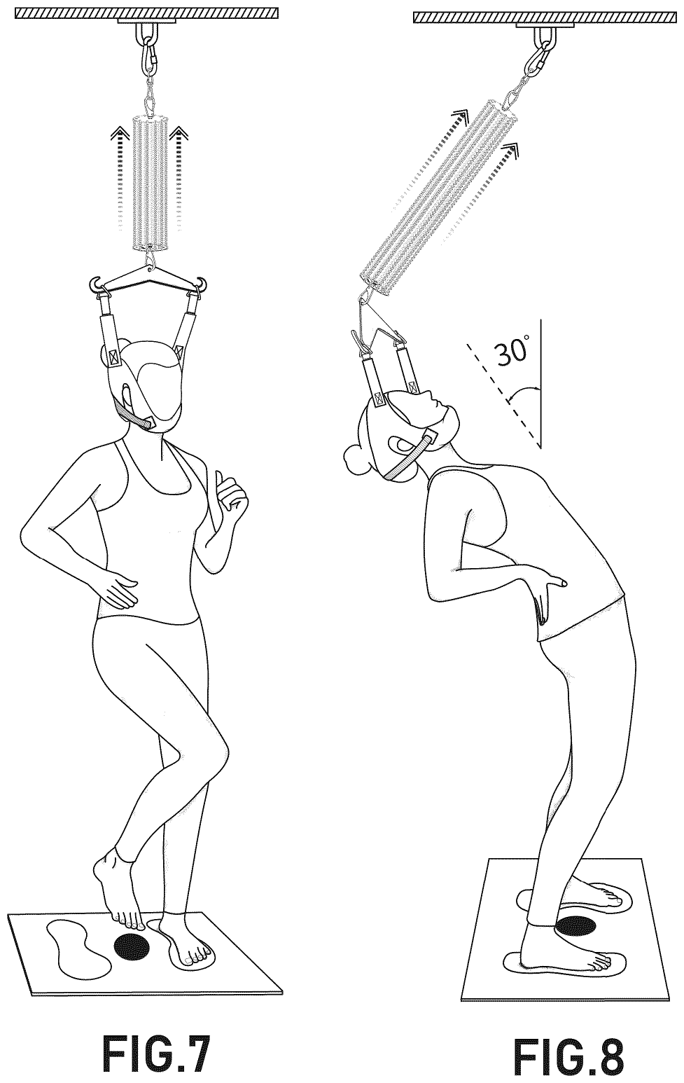

As depicted in FIGS. 5, 6, and 7, the patient 120 engage in exercises involving neck rotation, chest stretching, and marching in place while utilizing the cervical traction apparatus 100. These exercises, conducted with the head halter 160 securely affixed to the patient's head 121, serve to effectively relieve muscle tension throughout the traction procedure. To ensure the precise application of cervical traction at the correct angle, patients maintain their feet 122 consistently within the designated foot outlines 172 imprinted on the positioning mat 170 throughout the entirety of the traction session.

As depicted in FIG. 8, patient 120 is engaged in a spinal extension stretching exercise using the cervical traction apparatus 100. In this posture, the patient 120 leans backward in a controlled manner, reaching their maximum extension while stabilizing their balance by resting their hands atop their pelvis, thereby achieving a 15-30 degree angle of flexion traction.

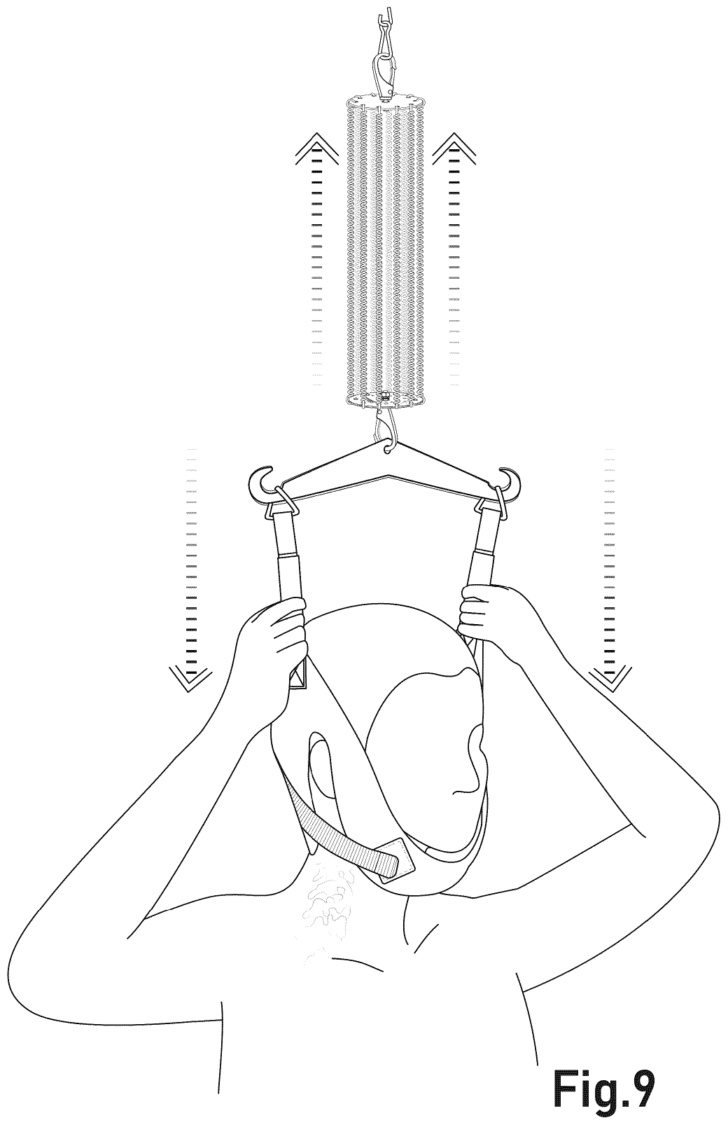

As illustrated in FIG. 9, patient 120 performs intermittent cervical traction by manually grasping the head halter 160 of cervical traction apparatus 110 with their hand. The head halter 160 is then gently lowered from a position under the chin to the base of the neck 123 of patient 120, and this specific posture is sustained for a designated intermittent period.

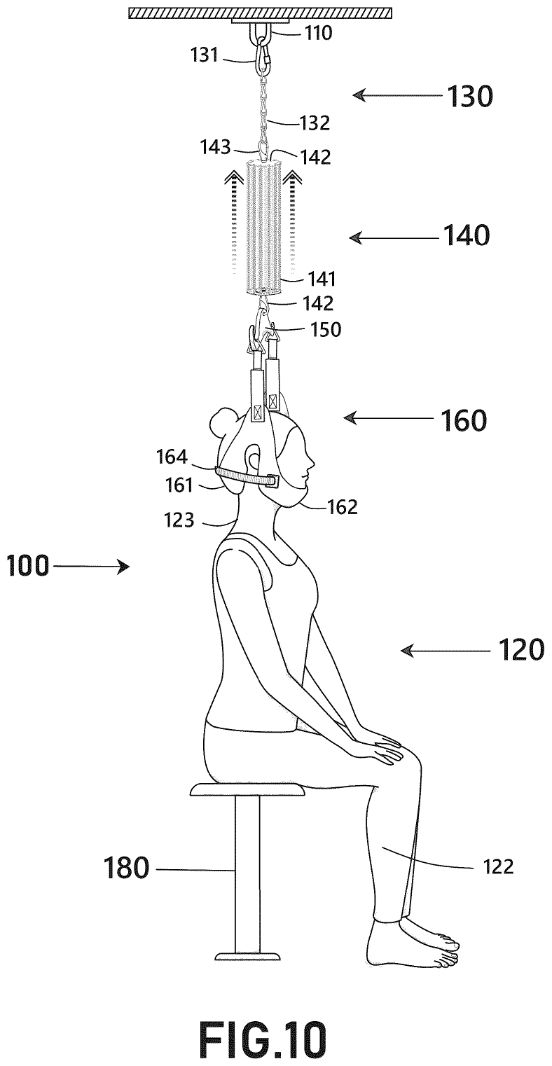

As depicted in FIG. 10, the patient 120 utilizes the cervical traction apparatus 100 while seated in conjunction with a chair 180, suitable for situations in which prolonged standing is not feasible. The chair 180 is positioned so that its central axis aligns precisely with the overhead suspension hook, establishing a vertical alignment perpendicular to the floor, akin to the positioning mat 170. The height of the chair 180 should be appropriately adjusted to ensure that the patient 120 is seated with the feet 122 resting flat on the floor.

As an illustrative example, the extension springs 141, constructed from SUS304 stainless steel material with specific dimensions including a wire diameter of 0.8 mm, a centre diameter of 7.2 mm, 293 active coils, and a free length height of 250 cm, demonstrate their ability to generate unique forces when subjected to various levels of deflection.

When the patient 120 applies a downward force to move the head halter 160 from the top of the head 121 to the position of the neck 123, subsequently securing it to the head 121, the resulting vertical distance corresponds to the measurement from Menton (the bottom of the chin) to the top of the head 121. This measurement, referred to as “Menton to top of head,” typically falls within the range of 19.8 cm to 25.5 cm for both men and women, as reported in Wikipedia.

For a comprehensive understanding, the forces generated by different combinations of parallel extension springs 141 at deflections of 20 cm, 23 cm, 25 cm, 30 cm, and the maximum deflection length of 37 cm are meticulously documented in the accompanying spreadsheet.

| Deflection | Extension Springs Number(Pound) | | | | | | | |
|---|---|---|---|---|---|---|---|---|
| Length | 4 | 6 | 7 | 8 | 9 | 10 | 11 | 12 |
| 20 cm/7.8″ | 5.75 | 8.63 | 10.07 | 11.51 | 12.95 | 14.39 | 15.83 | 17.26 |
| 23 cm/9.05″ | 6.65 | 9.98 | 11.64 | 13.31 | 14.97 | 16.64 | 18.30 | 19.96 |
| 25 cm/9.8″ | 7.19 | 10.79 | 12.59 | 14.39 | 16.19 | 17.98 | 19.78 | 21.58 |
| 30 cm/11.8″ | 8.65 | 12.98 | 15.14 | 17.30 | 19.46 | 21.63 | 23.79 | 25.95 |
| 37 cm/14.6″ | 10.88 | 16.32 | 19.04 | 21.76 | 24.48 | 27.20 | 29.92 | 32.64 |

Considering the load exerted by the spread bar 150 and the head halt 160 loading under the cohesive framework 140, the traction force must be precisely calibrated by subtracting the combined weight of these two components. Consequently, the adjusted traction force, factoring in the weight of both items as one pound, will be presented in the spreadsheet provided below for your reference.

| Deflection | Extension Springs Number(Pound) | | | | | | | |
|---|---|---|---|---|---|---|---|---|
| Length | 4 | 6 | 7 | 8 | 9 | 10 | 11 | 12 |
| 20 cm/7.8″ | 4.75 | 7.63 | 9.07 | 10.51 | 11.95 | 13.39 | 14.83 | 16.26 |
| 23 cm/9.05″ | 5.65 | 8.98 | 10.64 | 12.31 | 13.97 | 15.64 | 17.30 | 18.96 |
| 25 cm/9.8″ | 6.19 | 9.79 | 11.59 | 13.39 | 15.19 | 16.98 | 18.78 | 20.58 |
| 30 cm/11.8″ | 7.65 | 11.98 | 14.14 | 16.30 | 18.46 | 20.63 | 22.79 | 24.95 |
| 37 cm/14.6″ | 9.88 | 15.32 | 18.04 | 20.76 | 23.48 | 26.20 | 28.92 | 31.64 |

It has been noted that to attain substantial cervical traction, the traction force should equal or exceed the weight of the head 121, which typically constitutes around 8.2% of the patient's 120 total body weight. We are employing this 8.2% factor to retroactively determine the corresponding body weight for which the aforementioned traction force can be applied, as outlined below.

| Deflection | | | | | | | | | |
|---|---|---|---|---|---|---|---|---|---|
| Length | Body weight(Pound) | | | | | | | | |
| 20 cm/7.8″ | 58 | 76 | 93 | 111 | 128 | 146 | 163 | 181 | 198 |
| 23 cm/9.05″ | 69 | 89 | 110 | 130 | 150 | 170 | 191 | 211 | 231 |
| 25 cm/9.8″ | 76 | 97 | 119 | 141 | 163 | 185 | 207 | 229 | 251 |
| 30 cm/11.8″ | 93 | 120 | 146 | 172 | 199 | 225 | 252 | 278 | 304 |
| 37 cm/14.6″ | 120 | 154 | 187 | 220 | 253 | 286 | 320 | 353 | 386 |
| Number of Springs | 4 | 5 | 6 | 7 | 8 | 9 | 10 | 11 | 12 |

Based on the aforementioned sample, it becomes clear that the traction force generated by the parallel extension springs 141 within the cohesive framework 140 can be customized by altering the quantity of parallel extension springs 141 and the extent of deflection. This adaptability is designed to meet the specific requirements of the majority of patient groups, accommodating variances in weight and individual preferences, thereby ensuring effective cervical traction and the attainment of optimal outcomes. It is noteworthy, however, that alternative materials, varying wire sizes, and free extension height options for the springs can also be employed to cater to diverse weight variations and individual preferences.

In certain implementations, as illustrated in FIGS. 2 and 3, the cohesive framework 140 is designed in a cylindrical formation, consisting of an upper disc and a bottom disc, which function as connection panels 142. However, it should be noted that alternative shapes capable of utilizing parallel spring force to apply traction and easily adjusting the traction force by adding or removing extension coil springs can be employed.

In certain implementations, as illustrated in FIG. 3, the cohesive framework 140 features a circular arrangement of holes 1412 along the edges of both the upper disc and bottom disc, serving as load points. However, it should be noted that alternative attachment points capable of securely holding the extension coil springs in a parallel position can be utilized.

In certain implementations, as illustrated in FIG. 3, the cohesive framework 140 allows for the incorporation of up to twelve extension springs 141 using the twelve holes 1412 along the connection panel 142 as load points. However, it should be noted that alternative arrangements capable of accommodating different maximum numbers of extension springs141, which are necessary to meet the effective cervical traction requirements of the majority of patients, can be employed.

In specific embodiments, the adjustable chain 130, the spread bar 150, and all constituents of the cohesive framework 140 are fabricated from stainless steel. The head halter 160 straps are crafted from nylon material, enveloped in leather, and cushioned with memory foam, while the two attachment points 163 are constructed from stainless steel. The positioning mat 170 is manufactured using foam rubber material, featuring a printable textured surface. It is important to acknowledge that alternative materials, recognized by those skilled in the field, could also be employed for these components.

The specific examples shown herein are provided solely as illustrative discussions of the embodiments of the present invention, serving the purpose of presenting what is believed to be the most useful and readily understandable description of the underlying principles and conceptual aspects. Accordingly, the intention is not to depict more details than necessary to comprehend the disclosure fundamentally. The description, in conjunction with the accompanying drawings, makes it evident to those skilled in the art how various forms of the presently disclosed invention can be embodied in practice.

While the operations are presented in a specific order in the drawings, it should be understood that this does not mandate performing the operations in the exact order shown or in a sequential manner, nor does it imply that all illustrated operations must be executed to achieve the desired results.

What is claimed is:

1. A cervical traction apparatus designed for employment alongside a patient and an anchor point, optionally in conjunction with a chair, comprises of:
A cohesive framework comprises multiple extension springs arranged in parallel, each featuring two hooks for attachment to opposite connection panels, each of which incorporates a centrally located swivel hook;
An adjustment chain consists of multiple carabiner clips and an interlocked chain segment;
A spreader bar featuring a single lifting point situated at the top centre and two pick points located at the opposite ends of the bottom;
A head halter consists of two cross straps with hook and loop adjustments, as well as two attachment points on either side;
A positioning mat featuring a central printed dot, flanked by two printed foot outlines on either side.

2. In the apparatus of claim 1, wherein load points are evenly and symmetrically integrated into each connection panel within the cohesive framework, ensuring a secure and parallel alignment of the extension springs.

3. In the apparatus of claim 1, wherein each side of the extension springs is equipped with attachment points that ensure secure attachment with the connection panel throughout the traction session, while also allowing for manual addition or removal from the connection panel of the cohesive framework if necessary, providing flexibility as needed.

4. In the apparatus of claim 1, a swivel attachment point is positioned centrally within each connection panel, which enables the cohesive framework to be angled differently without any twisting.

5. A method for performing cervical spine traction, comprising:
5.1 Providing a cervical traction apparatus with an anchor point, optionally in conjunction with a chair:
A cohesive framework comprises multiple extension springs arranged in parallel, each featuring two hooks for attachment to opposite connection panels, each of which incorporates a centrally located swivel hook;
An adjustment chain consists of multiple carabiner clips and an interlocked chain segment;
A spreader bar featuring a single lifting point situated at the top centre and two pick points located at the opposite ends of the bottom;
A head halter consists of two cross straps with hook and loop adjustments, as well as two attachment points on either side;
A positioning mat featuring a central printed dot, flanked by two printed foot outlines on either side.
5.2 Secure the adjustable chain to the anchor point and hang the cohesive framework from the opposite end of the chain;
5.3 Hang the spread bar from the bottom of the cohesive framework, and then attach the head halter to the two points on the spread bar;
5.4 Place the positioning mat on the floor, ensuring that the printed middle dot aligns with the anchor point, creating a right-angle intersection with either the floor or anchor point, as needed.

6. The method of claim 5, wherein employs an anchor point, which may manifest as a mounted ceiling hook, a wall bracket, or a free-standing frame equipped with a hanging hook. This anchor point is positioned to the floor, ensuring adequate headroom between the head halter and the patient's head when the apparatus is suspended from the anchor point while the patient assumes an upright standing position.

7. In the method of claim 5, wherein the length of the adjustable chain is adjusted to position the head halter just above the patient's head prior to the initiation of traction.

8. The method of claim 5, wherein the cohesive framework assembly applies a traction force to the cervical spine by utilizing the restoring energy of the parallel extension springs when the head halter is manually pulled downward by the patient and securely attached to the patient's head.

9. In the method of claim 5, wherein the traction force can be adjusted by the patient based on their individual requirement for effective traction or personal preference, by adding or removing the extension springs within cohesive framework.

10. The method of claim 5, wherein involves the patient utilizing the detailed and user-friendly information provided in a user guide accompanying the apparatus to calculate and determine the optimal number of parallel extension springs for effective traction.

11. In the method of claim 5, wherein the positioning mat is placed on the floor with the central printed dot serving as a visual reference point, aligning with the anchor point to form a vertical line perpendicular to the floor.

12. The method of claim 5, wherein involves the patient positioning in a standing posture throughout the entire traction session, with their feet placed on the printed foot outline of the positioning mat.

13. The method of claim 5, wherein involves the patient being in a free-standing position throughout the entire traction session, with hands and legs in a relaxed and unrestricted position throughout the entire traction session.

14. The method of claim 5, wherein involves the patient performing exercises such as neck rotation, chest stretch, shoulder stretch to release tension in related muscles during the cervical traction session.

15. The method of claim 5, wherein involves the patient performing a spinal extension stretch by leaning back while maintaining balance in a standing posture, thereby achieving a different angle of cervical traction.

16. The method of claim 5, wherein involves the patient performing intermittent cervical traction by gripping the head halter, lowering it from the chin to the base of the neck and maintaining this position for a specified duration.

17. The method of claim 5, wherein optionally utilizes a chair, aligning its central axis precisely with the anchor point to establish a vertical alignment perpendicular to the floor, and the chair's height is adjusted to ensure the patient's feet are flat on the floor.

18. The method of claim 5, wherein involves the patient optionally engaging in cervical traction while seated in a chair.
